(19) United States
(12) Patent Application Publication
(10) Pub. No.: US 2009/0015820 A1
(43) Pub. Date: Jan. 15, 2009

(54) Method and apparatus for the analysis of foreign gas phase in containers

(76) Inventors: Thomas Bohe, Baden-Baden (DE); Dirk Fey, Neewiller (DE)

Correspondence Address: PATENTANWAELTE LICHTI + PARTNER GBR, POSTFACH 41 07 60, D-76207, KARLSRUHE, DE

(21) Appl. No.: 11/876,804

(22) Filed: Oct. 23, 2007

(30) Foreign Application Priority Data
Oct. 26, 2006 (DE) 10 2006 050 491.7

(51) Int. Cl. G01N 21/33

(52) U.S. Cl. 356/51; 356/326

(57) ABSTRACT

The invention relates to a method and an apparatus for the analysis of foreign gas phases in containers, e.g. water containers, in particular to discard contaminated containers. In order to achieve an efficient and reliable detection of foreign gas phases it is recommended that at least one gas sample extracted from the container is analyzed spectroscopically via UV spectroscopy. An associated apparatus thereby provides measuring equipment for the spectrometric analysis of the foreign gases by means of UV spectroscopy.

The invention relates to a procedure and an apparatus for the analysis of foreign gas phases in containers, e.g. water containers, in particular, to discard contaminated containers.

When recycling returnable containers, there is the problem of a qualitative and quantitative detection and identification of fixed, liquid and gaseous contamination in order to prevent any negative effects on the taste and, in the extreme case, a toxic effect on the filled-in beverages. A high reliability in the detection of such harmful substances is indispensable, involving increasing industrial demands on productivity and efficiency. Furthermore, a wide range of possible applications of such a procedure for the detection of as many different contaminants as possible in containers of different size, form and material composition is desirable.

An apparatus for the analysis of the gaseous content of returned beverage bottles is already known, in which a gas sample taken from a beverage bottle is analyzed spectroscopically in a wavelength range between 3.2 μm and 3.6 μm. Disadvantageous is that such a procedure is only suitable for the analysis of beverage bottles having a small volume and that the practical procedure is extremely difficult.

Departing therefrom, the task of the invention is to define a procedure and apparatus which makes the analysis of foreign gas phases in containers reliable and efficient and can nevertheless be used for various types of containers, in particular with large internal volumes, as well as for the detection of various types of contaminants, which are extremely complicated and difficult to detect in conventional procedures.

The stated task is solved by the invention with a procedure of the above mentioned kind, in that at least one gas sample taken from a container is analyzed spectroscopically by means of UV spectroscopy. The stated task is also solved with an apparatus of this kind, having measuring equipment for the spectral analysis of the foreign gases by means of UV spectroscopy.

With the solution according to the invention, it is possible to detect contaminants with a particularly deleterious effect, e.g. benzine or ammonia, reliably and efficiently, since the cross section of an absorption measurement in the UV range is ten times that of conventional measuring methods. This, in particular, reduces the time interval required for one measurement run many times over. Moreover, the expenditure as to the apparatus is reduced.

A preferable version of the measuring equipment according to the invention provides equipment for the spectral spatial decomposition of a measuring beam after having passed through a foreign gas sample and a series of detectors arranged side by side as well as a grid or prism.

A concrete version provides that gas samples are analyzed in a wavelength range from 190 to 390 nm, the measuring equipment providing a UV radiator and detection equipment for detecting UV radiation in the range from 190 to 390 nm.

A preferable version provides that the gas sample taken is passed through a measuring cell which has most favorably a substantially cylindrical, elongated form. It is also suggested that the UV light is radiated into the measuring cell substantially along its longitudinal direction. A particularly effective increase of the measuring accuracy can be easily achieved by repeatedly traversing the UV light of the measuring cell in its longitudinal direction. It is suggested that the UV light traverses the measuring cell in the longitudinal direction at least twice, in the preferable version, at least eight times. A measuring cell according to the invention provides reflectors at both ends for an at least eightfold reflection of the irradiated UV light. Such a measuring cell can be designed compactly with high efficiency.

Due to the problem of extracting a homogeneous quantity of a foreign gas sample especially with larger container volumes, it is suggested that the foreign gas sample is extracted by injecting a neutral gas into the container. An apparatus according to the invention provides injection equipment for injecting a neutral gas into the container and for driving a foreign gas sample out of the container.

A preferable further development of the procedure according to the invention provides that the gas sample is extracted from the container to be examined by tightly placing a measuring head onto its opening. The measuring head can preferentially be lowered pneumatically or hydraulically onto the opening of the container, in particular by activating a light barrier when passing through. Therefore, a further development of the apparatus according to the invention provides equipment for closely placing a measuring head onto an opening of the container to be examined, which can have a hydraulic or pneumatic cylinder for placing the measuring head onto the opening of the container. Furthermore, a light barrier for the activation of the placing process can be provided.

A particularly efficient extraction of the foreign gas sample—moreover complying with the industrial demands on the recycling of a high number of containers—can be achieved by extracting the foreign gas sample from the container during a continuous or discontinuous conveyance of the container under measuring equipment. In a preferable version, the measuring head is lifted off the container after extraction of the foreign gas sample. A particularly easy return of the measuring head to its starting position can be achieved by urging the measuring head against a guide curve. An apparatus according to the invention provides conveying equipment for the continuous or discontinuous conveyance of the container, in which the measuring head can be carried along by the moved container.

In order to achieve in particular a high reproducibility of the measuring results in a straightforward manner, a preferable version of the apparatus according to the invention provides that the measuring cell has a rigid connection with at least one tube arranged in parallel to the direction of extension of the measuring cell. The measuring cell is therefore stabilized by a rigid connection with at least one tube arranged in parallel to the direction of extension of the measuring cell.

Thus, a stabilization of the measuring cell is achieved in a simple and constructive way, with a small spatial extent of the entire stabilizing measuring equipment. The fundamental idea of this invention is therefore a damping of the vibrations induced by environmental influences and a strong decay behavior of these due to an increased inertia of the resonating body. This also reduces the excitation energy of molecular motion of the gas to be analyzed, a reduction of the pressure broadening, and an increase of the absorption coefficient and thus a resulting noise suppression of the measuring spectrum and an increase of the measuring accuracy. Such a reduction of perturbations on the measuring process is of great importance especially for measurements close to the noise limit, e.g. when determining the benzol content in the atmosphere of the container.

In a very preferable further development of the apparatus according to the invention, a particularly high stabilization of the measuring cell is achieved with the measuring cell having a rigid connection on both sides, each with at least one tube arranged in parallel to the direction of extension of the measuring cell. For the same purpose, it can also be provided that the tubes arranged in parallel to the direction of extension of the measuring cell on both sides are rigidly interconnected. In particular, it can be provided that the measuring cell has at least one further rigid connection in circumferential direction with each tube arranged in parallel to the direction of extension of the measuring cell.

In a preferable further development, the tube(s) arranged in parallel to the measuring cell is/are made of a material with a smaller or the same thermal expansion coefficient as glass, which ensures that the rigid connection and thus the stabilization of the measuring cell is maintained even at a varying ambient temperature and in particular at a varying temperature of the gas mixture to be analyzed. This allows for simple handling of the spectroscopy equipment in measurements with different sample temperatures, which can be set to an appropriately low value, in particular to reduce the pressure broadening and for noise suppression. In particular for benzene spectroscopy, temperature-dependent measurements might be advantageous since benzene molecules only form van der Waals complexes among each other which are extremely unstable even far below room temperature so that temperature changes do not influence the measuring spectrum to a great extent but could lead to an increase in the measuring accuracy. For temperature monitoring it is further provided that the measuring cell is thermostatic.

In a highly preferable version, the tube(s) arranged in parallel to the measuring cell is/are made of the same material as the measuring cell, in particular of glass. This leads to a particularly simple and low-cost production of individual stabilized spectroscopy equipment, since measuring cells freely available on the market can be used as tubes for stabilization of the actual measuring cell. In a further development, such tubes intended for stabilization can also be used as measuring cells, e.g. for the spectroscopy of a comparison gas. In a further preferred version, the tube(s) arranged in parallel to the measuring cell has/have the same length and/or the same diameter as the measuring cell. It is furthermore provided that the measuring cell has a length between 50 and 150 cm, in particular in the range of 100 cm, and a diameter between 1 and 5 cm, in particular in the range of 3 cm. This is an optimized compromise between the radiative length required for the measuring accuracy and a compact measurement setup, in particular for determination of a benzine content in the region of 3 ppb.

In another preferable further development, the rigid connection is formed by one or several rigid connecting link(s) arranged on the surface of the tube(s) and the surface of the measuring cell. This allows for a great deal of freedom in the configuration of the connection; in particular, the arrangement of almost any number of connecting links is possible. For the aforementioned reasons, it is also provided that the rigid connecting link is made of a material with a smaller or the same thermal expansion coefficient than/as glass. Preferably, the rigid connection is additionally or solely formed by one or two rigid connecting link(s) each arranged at the end of the measuring cell and of the tube(s). Apart from an (additional) stabilization of the measuring cell, this results in a compact design of the measuring equipment, since such a rigid connecting link arranged at the end of the measuring cell may be provided with equipment for guiding a measuring beam through the measuring cell, which additionally results in a substantial stabilization of the measuring beam. This is especially advantageous in the case of frequent changes of the measurement environment or for measurements in environments causing misalignment of the measuring beam, e.g. in the vicinity of industrial facilities, so that a laborious and time-consuming readjustment and optimization of the course of beam can be avoided and, after one-time adjustment of the measuring beam, a simple application of the spectroscopy equipment is possible even for users inexperienced in the field of optics. For this purpose, an end-side connecting link is provided with at least one parabolic reflector for feeding in and adjusting a beam from a light source into the measuring cell. Preferably, the other end-side connecting link is provided with a reflector for reflecting the fed-in light beam so that the measuring cell is passed through twice by the measuring beam and as long a radiative path as possible is achieved with equipment design as compact as possible. It is furthermore provided that the end-side connecting link with the parabolic reflector for feeding in a light beam is provided with another parabolic reflector for uncoupling the light beam reflected at the other end-side link and that the uncoupled light beam is fed into a detector and/or spectrometer. In this manner, the light beam can be coupled into the measuring cell from an optical fiber, e.g. a fiber optic cable, and/or uncoupled from the measuring cell into an optical fiber. The coupling into or uncoupling from the optical fibers is effected by the parabolic reflectors arranged in an end-side connecting link. Alternatively, optical lenses can also be used.

Especially with regard to use of the spectroscopy equipment according to the invention for detection of the benzine content, a xenon light source radiating in the UV range, in particular in a wavelength range between 220 nm and 280 nm, can be used as a light source and a silicon array as detector/spectrometer. Alternatively, a light source radiating in the infrared range can be used as light source and an HgCdTe array as the detector/spectrometer. The spatial spectral decomposition of the received signal is effected via a prism or preferably a grid. A high-resolution detector array with a measurement resolution of up to 1024 pixels can be used. In such a case, the required grid constant of the spectrometer is sufficiently high that the intensity impinging on a pixel is highly reduced compared to the input signal. In consequence thereof, a further development of the apparatus according to the invention provides for noise reduction via lock-in technology in which the ejected light beam is detected via a lock-in amplifier. An evaluation of the spectrum generally measured via the superposition of several spectrums can be carried out via a spectral unfolding into the individual spectrums by means of the PLS algorithm, with the unfolding of individual spectral peaks or spectrum shapes from each other and/or from background noise.

In general, (variable frequency) laser sources as well as spontaneously emitting light sources can be used, e.g. xenon gas discharge lamps or deuterium lamps. The latter are characterized by a wide emission spectrum but a low power density which might not be sufficient for the analysis of smallest quantities of material with low absorption coefficients. Conversely, a (variable frequency) laser source has a high power density but a limited wavelength range of excitation energy available for analyzing the gas. Alternatively, super-luminescent light sources can also be used, forming a compromise between broadband conventional radiators and laser emission sources with regard to spectral bandwidth and power density. When using a laser source, it can particularly be provided that at least sections of the measuring cell form the cavity of a laser. For example, a conventional laser can have an extremely low reflection coefficient on the side facing the measuring cell, e.g. be provided with an antireflection coating, so that the reflector limiting the laser cavity is formed by a reflector integrated in the end-side connecting link of the measuring cell. Such an arrangement allows for an essential improvement of the measuring accuracy when the laser is operated in the range of the threshold value, since in this range, it shows a high sensitivity with respect to absorption induced losses.

It shall be understood that the spectroscopy equipment according to the invention can be used not only in the absorption spectroscopy and the trace analysis. The advantages of the invention also take effect in, e.g. fluorescence spectroscopy.

Further advantages and features of the invention result from the claims and the following description in which an embodiment of the invention is explained in detail with reference to the drawings.

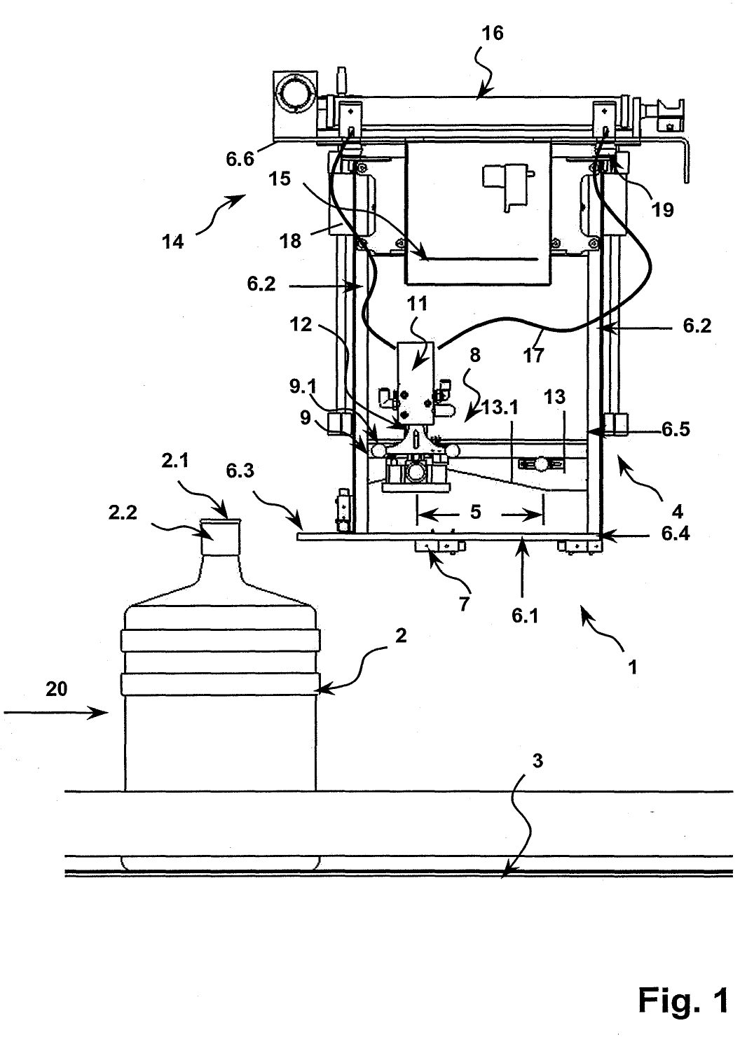

FIG. 1 shows a schematic side view of a version of the apparatus according to the invention for the analysis of foreign gas phases in five-gallon water containers;

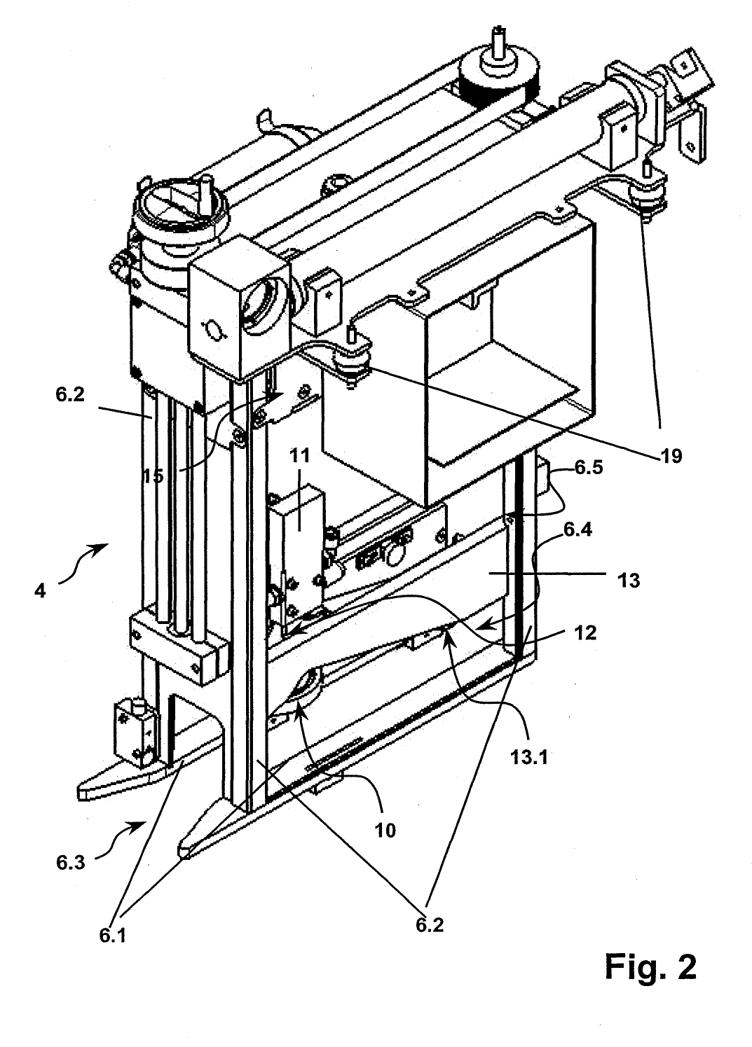

FIG. 2 shows a perspective view of an analysis station of the apparatus according to the invention shown in FIG. 1a;

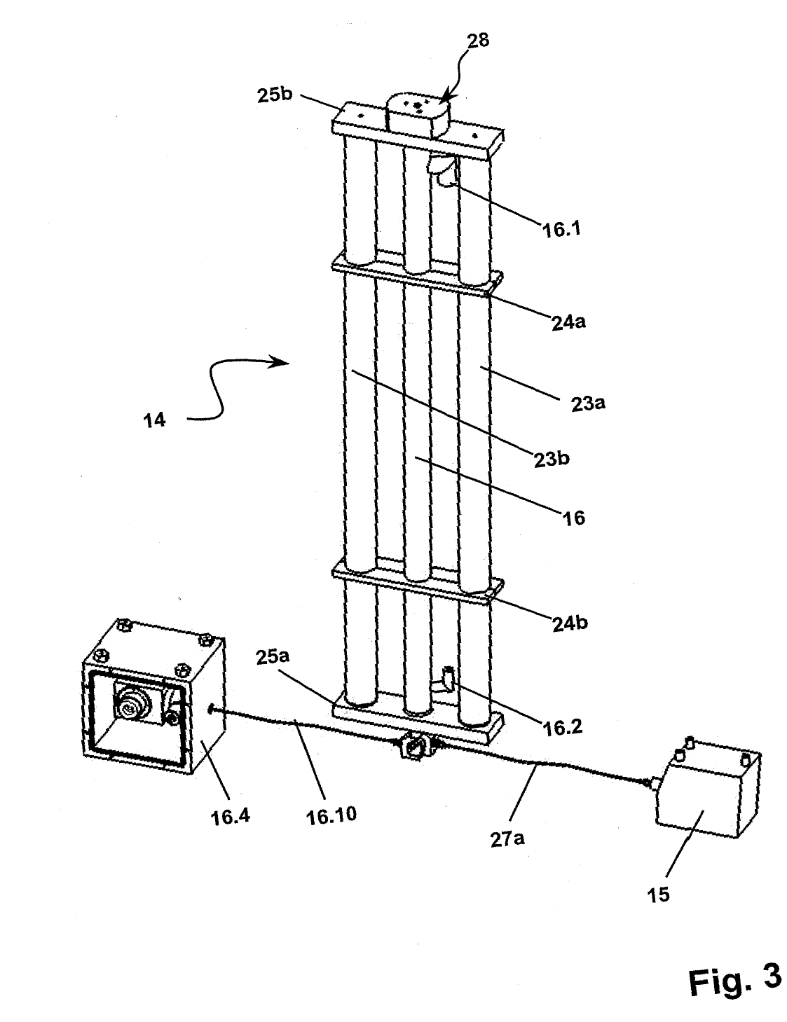

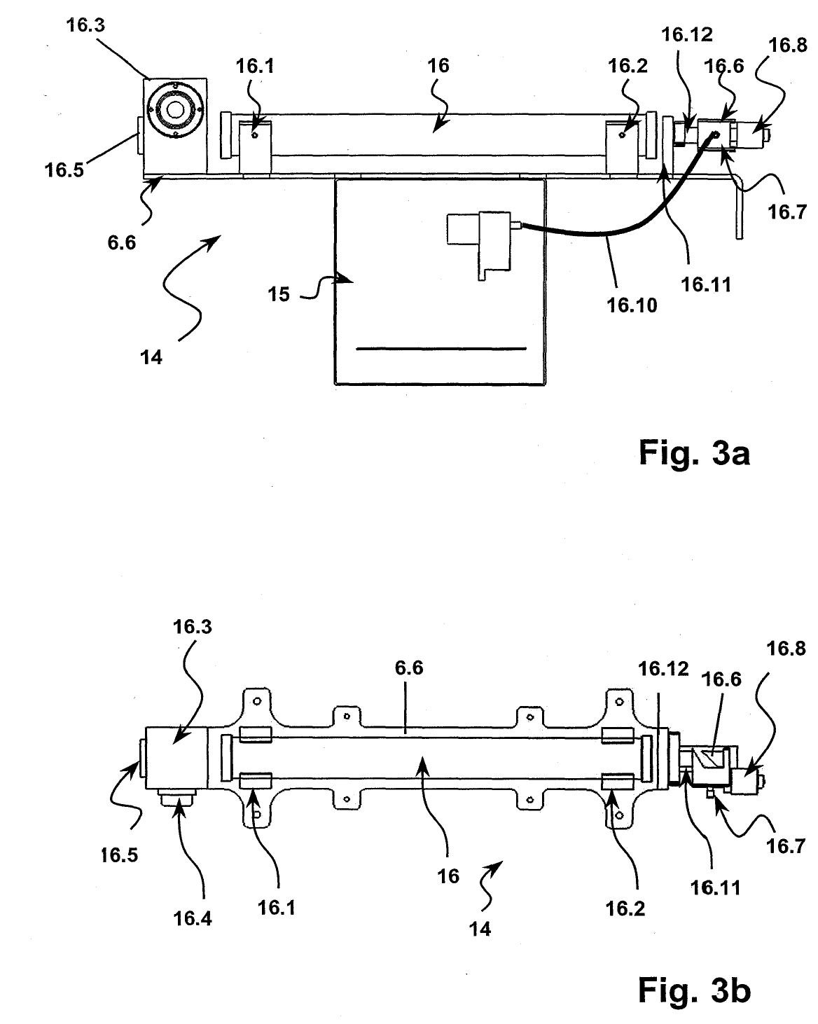

FIG. 3 shows a schematic representation of a spectroscopy equipment according to the invention;

FIG. 3a shows a section of the side view of FIG. 1 by means of which the measuring cell of the spectroscopy equipment of an apparatus according to the invention is shown in detail;

FIG. 3b shows a schematic plan view of the spectroscopic measuring system of an apparatus according to the invention shown in FIG. 3a;

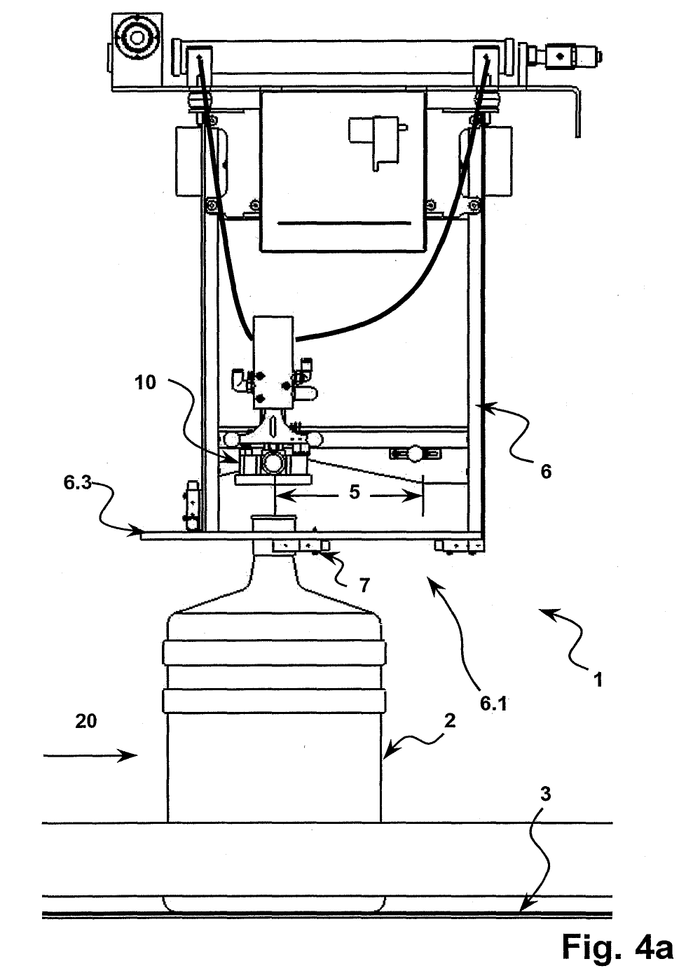

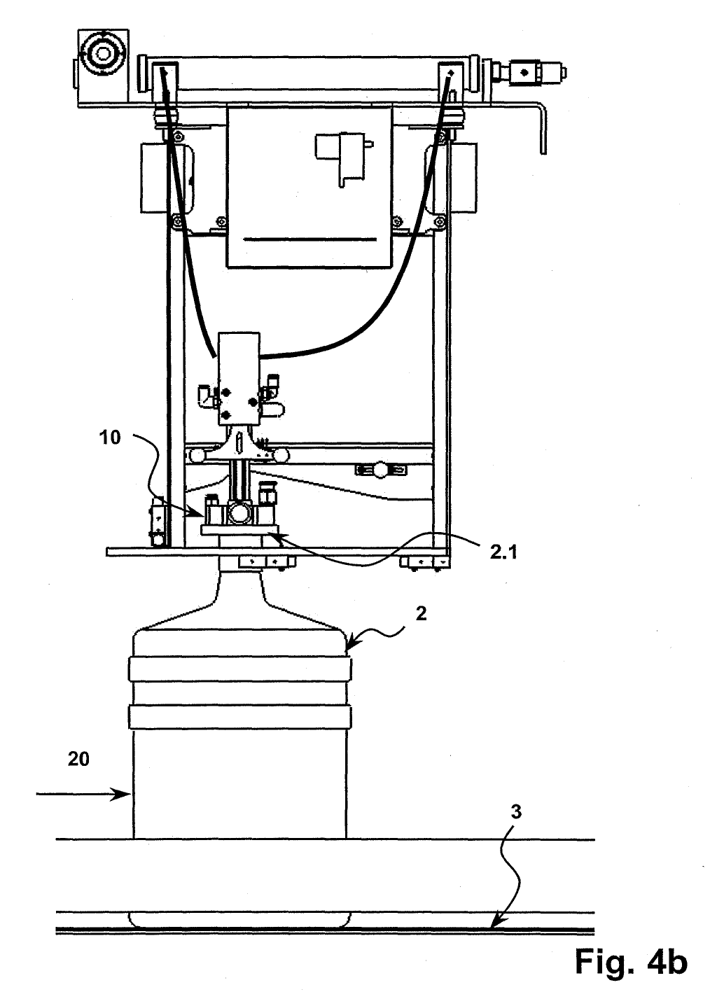

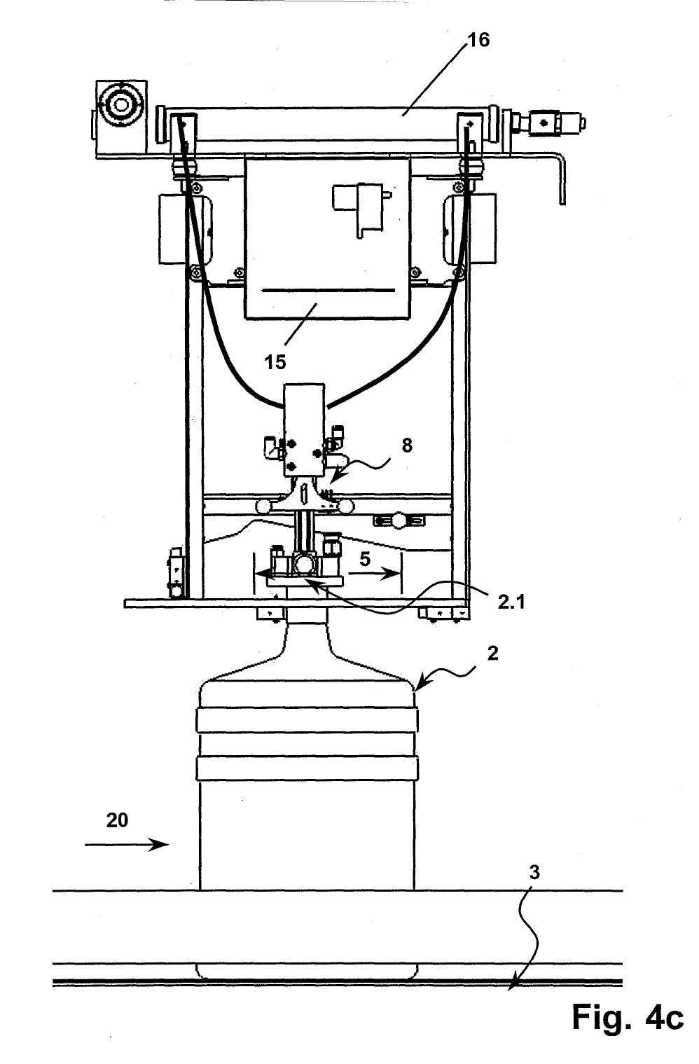

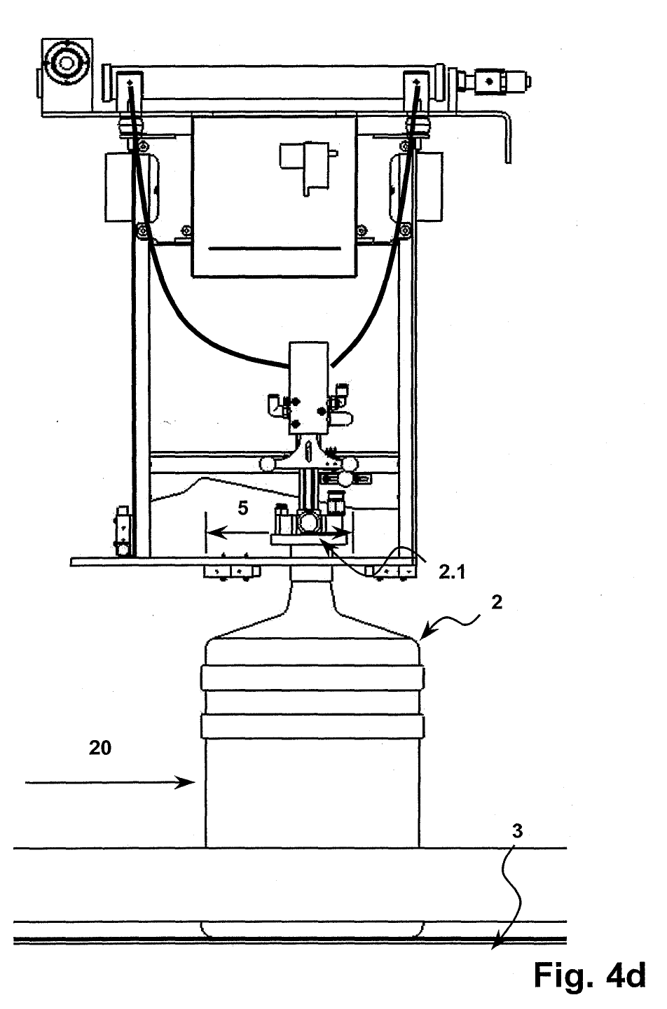

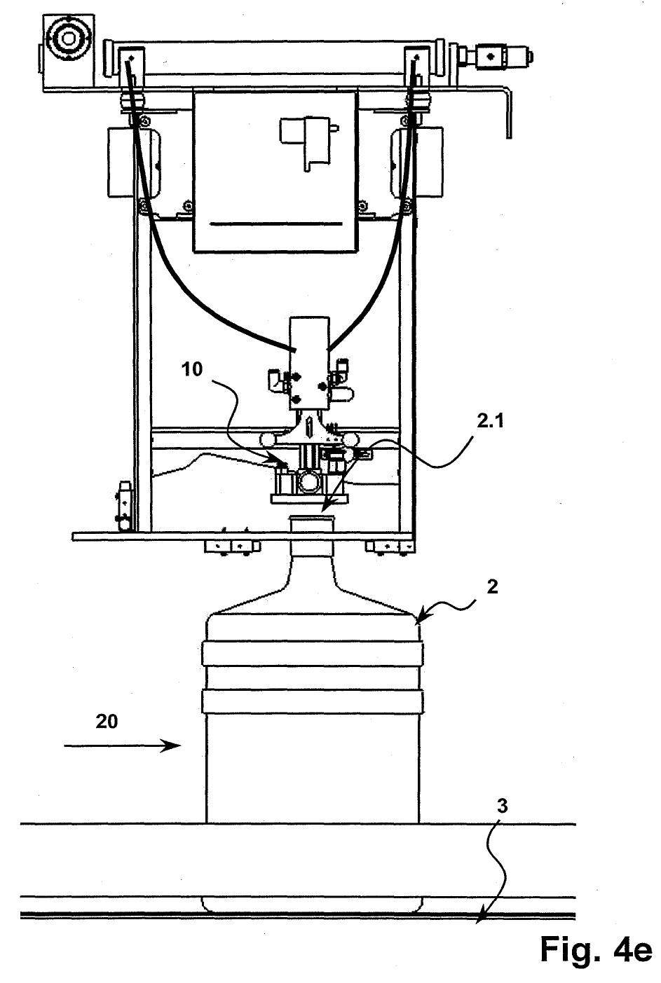

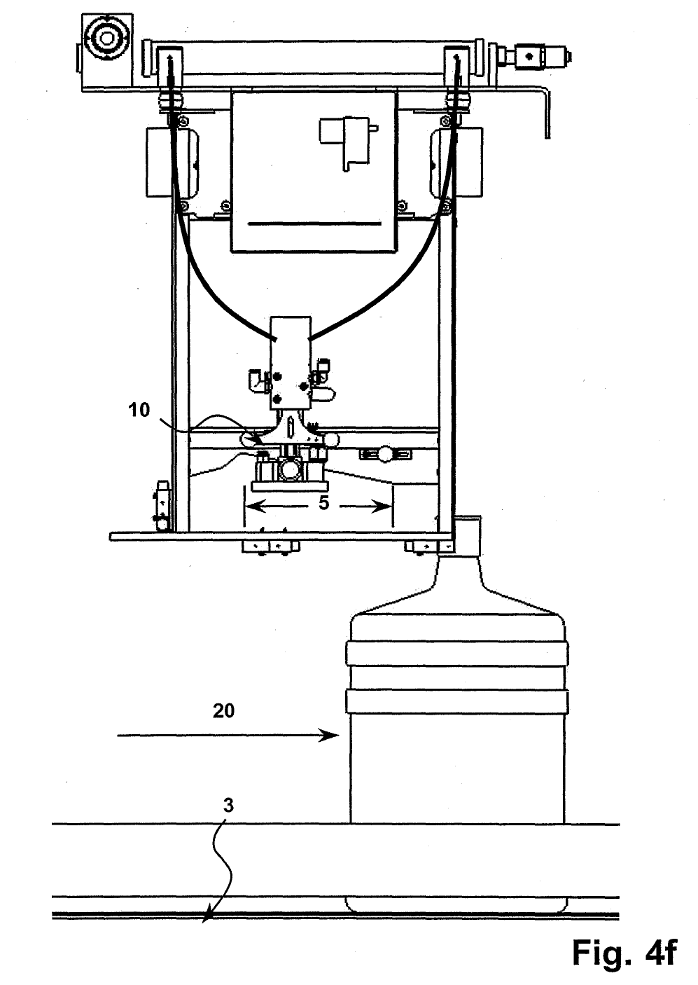

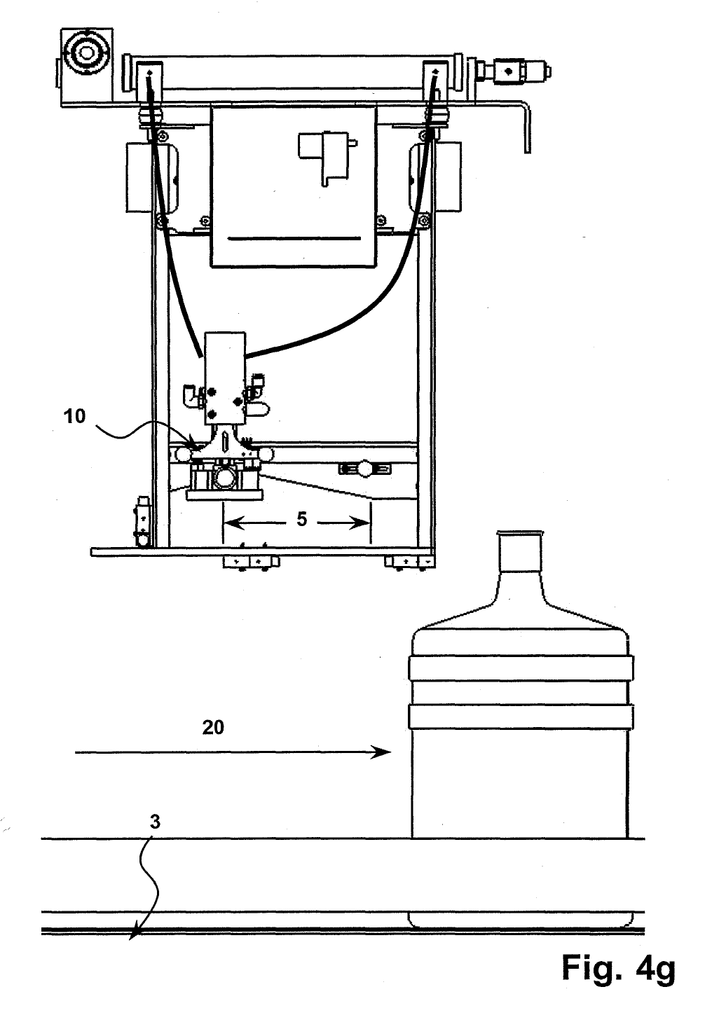

FIGS. 4a-4g each show a side view of the apparatus according to the invention shown in FIG. 1 by means of which the different steps of a procedure according to the invention for the analysis of foreign gas phases in five-gallon water containers are explained in detail; and

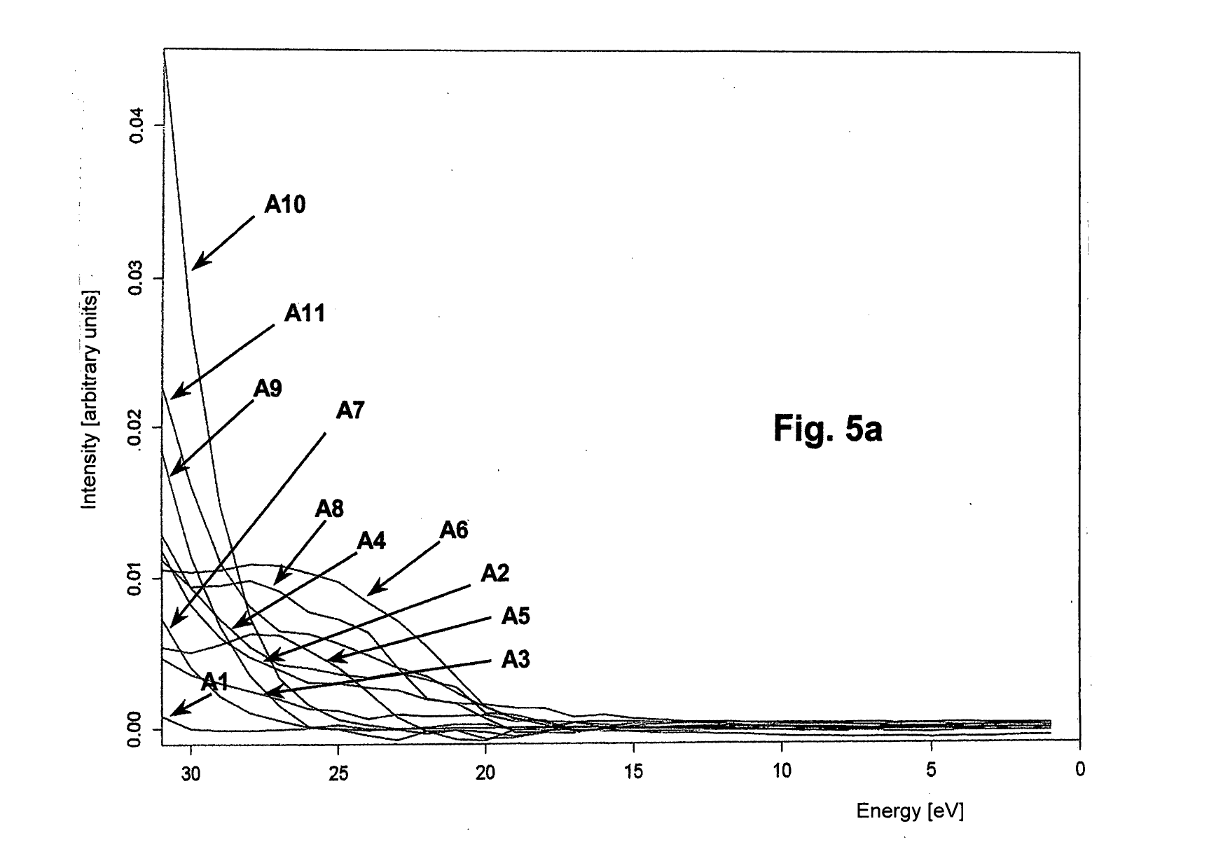

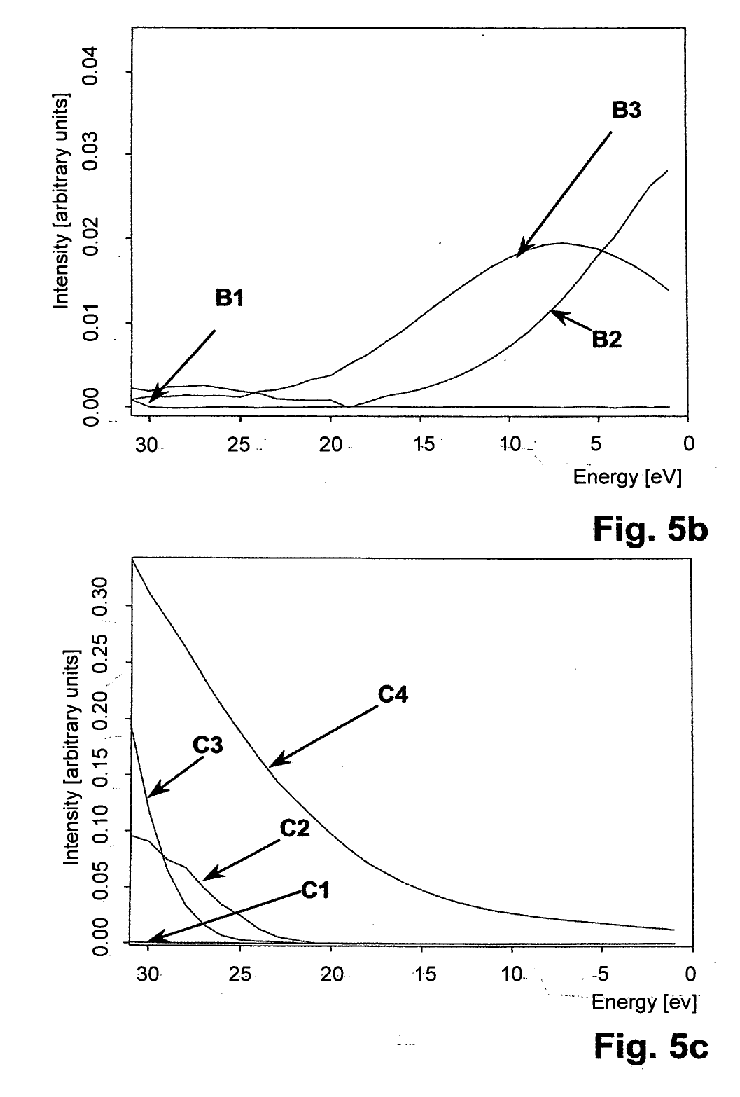

FIGS. 5a-5c shows various spectra of foreign gas phases in five-gallon water containers which were each detected in a procedure according to the invention.

FIG. 1 shows an apparatus according to the invention 1 for the analysis of foreign gas phases in five-gallon water containers 2 (approx. 19 l) which are continuously supplied and removed in transport direction 20 via transport equipment in the form of a conveyor belt 3. An extraction area 5 for gas samples intended for implementing the foreign gas analysis is thereby passed at the container opening 2.1 upper end of the respective container 2.

The extraction area 5 for gas samples is arranged in the lower end section of an analysis station 4 which is positioned above the container 2 in such a way that it holds the upper end section 2.2 of the container 2 with the container opening 2.1. The analysis station 4 has a substantially rectangular frame 6, the edges of which run vertically and are formed by four side bars 6.2. The lower edges of the frame 6 are limited by two lower longitudinal bars 6.1 extending parallel to the transport direction 20 so that an inlet 6.3 and an outlet 6.4 are formed for the containers 3 and the upper end section 2.2 of the container 2 can pass the gas extraction area 5 between the two lower longitudinal bars 6.1 in transport direction 20. For further stabilization, the frame 6 has two transverse bars 6.5 each located above the container opening 2.1 and the extraction area 5 for gas samples between two side bars 6.2 and extending perpendicularly to the transport direction 20, as shown in particular in the perspective view of the analysis station 4 in FIG. 2. On the upper side of the lower longitudinal bars 6.1 a light barrier 7 is located with the help of which entry of the upper end section 2.2 of the container 2 with the container opening 2.1 into the extraction area 5 for gas samples is registered. The frame 6 has a lifting spindle to adapt the vertical positioning to the dimensions of the container 2 or the belt 3.

In the area of the transverse bars 6.5, i.e. above the container opening 2.1 and the extraction area 5 for gas samples, the analysis station 4 has an extraction system 8 for gas samples which is pivot-mounted on two guide rails 9 located between two side bars 6.2 and parallel to one longitudinal bar 6.1 for displacement in transport direction 20 of the container 2 via associated guide rollers 9.1. The extraction system 8 for gas samples comprises a measuring head 10 located opposite to the container opening 2.1 and a pneumatically or hydraulically operated valve system 11 located above the measuring head 10 by means of which the measuring head 10 can be lowered to or lifted off the container opening 2.1 via an intermediate cylinder 12.

Between a respective guide rail 9 and longitudinal bar 6.1, one further longitudinal bar 13 is located above the extraction area 5 for gas samples, serving for the return of the extraction system 8 for gas samples. Towards this end, the longitudinal bars 13 each have a lower edge 13.1, sloping downwards in transport direction 20 of the container 2 and extending along the extraction area 5. This edge 13.1 effects an automatic return of the extraction system 8 for gas samples after completion of the gas sample extraction process against the transport direction 20 of the container 2 by redirecting the component of the force for lifting the measuring head 10, generated hydraulically or pneumatically and directed upwards, at the upper end of the measuring head 10 and along the edge 13.1 so that a guide curve is formed.

For spectroscopic determination of the chemical composition of a gas sample extracted from the container 2 via the extraction system 8, spectroscopy equipment 14 is located at the upper end section of the frame 6, which comprises a spectrometer 15 and a measuring cell 16. This measuring cell 16 is tube-shaped and extends above the upper limit of the frame 6 in transport direction 20 of the container 2, by which a high compactness of the system and at the same time a long radiative path of the extracted gas sample is achieved. The gas samples extracted from a container 2 are fed into or discharged from the measuring cell 16 by the extraction system 8 via a respective line 17, 18.

In order to prevent any falsification of the measuring result caused by vibrations of the frame 6 due to the extraction process of a gas sample and other interfering influences increasing the background noise of a measured absorption spectrum, the measuring cell is rigidly coupled with a base plate 6.6 and two attenuators 19 are each arranged at the ends between the frame 6 and the base plate 6.6, made of a gel or a similar vibration-isolating material.

The spectroscopy equipment 14 has a measuring cell 16 with two gas inlet ports 16a and 16b via which the measuring cell 16 can be evacuated or filled with a gas for trace analysis, e.g. contaminated carbon dioxide. For mechanical stabilization of the measuring cell 16, it is rigidly coupled with the tubes 23a and 23b via connecting elements 24a and 24b which are fixed in circumferential direction and completely embracing the tube.

The connecting elements 25a and 25b fixed to the ends of the measuring cell 16 and the tubes 23a and 23b are also adding to the stabilization of the measuring cell 16. These connecting elements according to the invention can be adjusted and fixed for coupling or uncoupling a measuring beam into or from the measuring cell 16, by which the measuring beam is stabilized, the measuring accuracy further improved and the design of the measuring equipment is as compact as possible. A first parabolic reflector is integrated in the connecting element 25a located on the front, for feeding in and adjusting the light beam coupled into the optical fiber by a light source 16.4, e.g. a UV lamp. The connecting element 25b located on the back furthermore has a reflector for reflecting the measuring beam, which can be adjusted via adjusting screws 28 in such a way that—according to the invention—the measuring beam passes the measuring cell twice to double the effective absorption rate compared to a single passing of the measuring beam so that a further improvement of the measuring accuracy can be achieved with an equipment design as compact as possible. An effective uncoupling of the measuring beam into an optical fiber 27a is effected via a second parabolic reflector integrated in the connecting element 25a. The back reflector can be adjusted via adjusting screws in such a way that the light beam fed in via the first parabolic reflector is reflected to the second parabolic reflector via the reflector at the back connecting element 25b and is fed into the optical fiber 27a. This is followed by measurement and evaluation of the absorption spectrum of the uncoupled measuring beam in a suitable detector/spectrometer 15.

Further divergent and focusing lenses (not shown) can be used for the coupling and uncoupling of the light beams into and from the optical fibers.

The detailed design of the measuring cell 16 of the apparatus according to the invention 1 for the analysis of foreign gases in containers 3 is shown in FIGS. 3a and 3b. For feeding or discharging the extracted gas sample into or out of the measuring cell 16, a gas inlet 16.1 and a gas outlet 16.2 are each disposed at the ends, to each of which one of the lines 17 or 18 is connected in a gas-tight manner. A housing 16.3 with a light source 16.4, e.g. a UV lamp, is disposed in front of the end, with the inlet 16.1, of the tube-shaped measuring cell 16 to pass UV light through the measuring cell 16 in a wavelength range of at least 190 to 390 Nm. The coupling of the UV light into the measuring cell is effected via a reflector 16.5, the course of beam in the measuring beam being adjustable via the position of the reflector which can be adjusted via an adjusting screw 16.5 located at the end of the lamp housing.

At the end of the measuring cell 16 with the gas outlet 16.2, a parabolic reflector 16.6 is provided for uncoupling the UV light beam from the measuring cell 16 into an optical fiber 16.10, e.g. as a fiber optic cable, and is connected to a lateral fiber optical connection 16.7 to feed the UV light into the spectrometer 15. The position of the parabolic reflector 16.6 and the course of beam for coupling into the optical fiber 16.10 is adjustable via a rotary switch 16.8.

The radiative path of the UV light given by the length of the measuring cell 16 is extended in order to improve the quality of the absorption spectrum to be measured for a given absorption coefficient. To do so, at least one more reflector 16.11 with a given reflection and transmission coefficient is provided between the end of the measuring cell 16 with the gas outlet 16.2 and the parabolic reflector 16.6. The position of the reflector 16.11 is adjustable via a ball head 16.12. By an appropriate adjustment of the course of beam via the adjusting screw 16.5 and the ball head 16.12 for adjusting the respective assigned reflectors, the UV beam can pass the measuring cell at least twice, preferably eight times, before it is fed into the spectrometer 15 via the parabolic reflector 16.6 and the optical fiber 16.10.

In the spectrometer 15, the fed-in UV light beam is spectrally decomposed via an appropriate grid the grid constant of which is adjustable or selectable depending on the desired measuring accuracy, the given intensity of the UV light beam, the desired period for implementing the measurements, etc. The absorption spectrum of the UV light beam is then measured with a series of detectors arranged side by side, the sensitivity of which each covers a portion of the spectral range to be measured. This allows for fast implementation of the measurement of the absorption spectrum so that the implementation of the measurement can be done in real time during extraction of the gas samples from the containers 2 in the extraction area 5.

The individual steps of a procedure according to the invention are displayed in FIGS. 4a to 4g, each showing an apparatus according to the invention 1 for the analysis of foreign gases in containers 2. In a first step (FIG. 4a), a container 2 is moved on a conveyor belt 3 through the inlet 6.3 of the longitudinal bar 6.1 of the frame 6 in transport direction 20 until it reaches the starting position of the gas extraction area 5. At this point, the passing of the upper end section 2.2 of the container 2 is registered by the light barrier 7 and the measuring process is initiated.

In a second step (FIG. 4b), the measuring head 10 is lowered pneumatically or hydraulically to the opening 2.1 of the container 2 so that it is placed tightly on the opening 2.1. In a third step (FIG. 4c), a neutral gas is injected into the container via the extraction system 8 for gas samples for removing any material residues adhering to the inner walls of the container and activating them into the gas phase, and for assimilating any gases and particles of material residues existing in the inner volume of the container into the neutral gas. At the same time, the injected neutral gas is extracted by suction via the extraction system 8 for gas samples and the dissolved samples of material residues. The extraction of the gas sample from the extraction system 8 as well as its forwarding to the measuring cell 16 and the determination of the absorption spectrum in the spectrometer 15 is done in the time interval in which the opening 2.1 of the container 2 passes the measuring region 5. After having reached the end position of the extraction area 5 of the opening 2.1 of the container 2 (FIG. 4d), the injection of the neutral gas into the container and thus the extraction of the gas sample is stopped. The absorption spectrum determined by the spectrometer 15 can now be analyzed and the container examined in this fashion either be discarded or further used, depending on the degree of contamination.

In the next step, the extraction head 10 is lifted pneumatically or hydraulically off the opening 2.1 of the container 2 (FIG. 4e). The measuring head 10 is thereby pressed against the guide curve of the lower edge 13.1 of the longitudinal bar 13 (FIG. 4f) so that it passes the extraction area 5 for gas samples against the transport direction 20 of the container 3 until it reaches an initial position at the beginning of the extraction area 5 again (FIG. 4g) and is thus ready for the next measuring process on a different container 3.

Since the injection of the neutral gas is preferably carried out at a constant given volume, pressure, and temperature, it is, for example, possible to compare the thus determined absorption spectrums of different containers with a reference spectrum of a contaminated container 3 with a known composition and quantity of the existing material residues.

FIG. 5a to 5c show such reference spectrums in a wavelength range from 190 to 390 Nm, which corresponds to an energy spectrum of 1 to 31 electronvolts, plotted against the determined intensity. The absorption coefficient A1 corresponds to an empty five-gallon water container formerly filled with water. Furthermore, absorption spectrums of empty five-gallon water containers are shown which were contaminated by a previous filling with a water solution containing 50 μl ethanol (A2), 0.5 l Sprite (A3), several ml of cider vinegar (A4), 500 μl parent solution of toluene in 1000 ml of water (A5), several milliliters of sun flower oil (A6), 25 μl isopropanol (A7), 13 ml 15W40 motor oil (A8), 2 μl diesel (A9), 1 μl benzine (A10) and 20 μl methanol (A11).

In FIG. 5b, the absorption spectrum of water (B1) is compared with the absorption spectrum of 200 μl soluted acetaldehyde (B2) and of ozone (B3). In the spectra shown in FIG. 5c, the absorption spectrum of water (C1) is compared with the absorption spectrum of a urine solution (C2) stored in a closed bottle for approx. one week as well as 0.5 l of beer (C3) with an alcoholic content of 4.8% and with 5 pressed cloves of garlic (C4) diluted with water.

### LIST OF REFERENCE NUMBERS

1 Apparatus for the analysis of foreign gas phases
2 Container
2.1 Opening of the container
2.2 Upper section of the container
3 Conveyor belt
4 Analysis station
5 Extraction area for gas samples
6 Frame
6.1 Lower longitudinal bars
6.2 Side bars
6.3 Inlet for containers
6.4 Outlet for containers
6.5 Transverse bars
6.6 Base plate
7 Light barrier
8 Extraction system for gas samples
9 Guide rails
9.1 Guide rollers
10 Measuring head
11 Valve system
12 Cylinder
13 Longitudinal bar
13.1 Edge
14 Spectroscopy equipment
15 Spectrometer
16 Measuring cell
16a Gas inlet port
16b Gas inlet port
16.1 Gas inlet
16.2 Gas outlet
16.3 Housing
16.4 Light source, UV lamp
16.5 Reflector with adjusting facility
16.6 Parabolic reflector
16.7 Optical fiber connection
16.9 Rotary switch
16.10 Optical fiber
16.11 Reflector
16.12 Ball head for adjustment
17 Gas supply line
18 Gas discharge line
19 Attenuators
20 Transport direction of the container
23a Tube
23b Tube
24a, 24b Connecting elements
25a Connecting element
25b Connecting element
27a Optical fiber
28 Adjusting screws

1-41. (canceled)

42. A method for the analysis of foreign gas phases in containers, in water containers, or in contaminated containers which are to be discarded, the method comprising the steps of:
a) extracting at least one gas sample from the container; and
b) analyzing the gas sample spectroscopically via UV spectroscopy.

43. The method of claim 42, wherein a spectrally fragmented beam is detected with a series of detectors arranged side by side.

44. The method of claim 42, wherein the gas sample is analyzed in a wavelength range from 190 to 390 Nm.

45. The method of claim 42, wherein the gas sample is passed through a measuring cell.

46. The method of claim 45, wherein the gas sample is passed through a substantially cylindrical, elongated measuring cell passed.

47. The method of claim 46, wherein UV light passes the measuring cell at least twice in longitudinal direction thereof.

48. The method of claim 46, wherein UV light passes the measuring cell at least eight times by means of reflection at ends thereof.

49. The method of claim 42, wherein a foreign gas sample is extracted by injecting a neutral gas into the container.

50. The method of claim 42, wherein the gas sample is extracted from the container by tightly placing a measuring head onto an opening thereof.

51. The method of claim 50, wherein the measuring head is lowered onto the opening of the container pneumatically, hydraulically, or with activation of a light barrier.

52. The method of claim 42, wherein a foreign gas sample is extracted from the container during a continuous or discontinuous conveyance of the container under measuring equipment.

53. The method of claim 52, wherein a measuring head is lifted off the container after extraction of the foreign gas sample.

54. The method of claim 53, wherein the measuring head is returned to a starting position by pressing the measuring head against a guide curve.

55. An apparatus for analysis of foreign gas phases in containers, in water containers, or in contaminated containers which are to be discarded, the apparatus comprising measuring equipment for spectrometric analysis, by means of UV spectroscopy, of foreign gases extracted from the containers.

56. The apparatus of claim 55, wherein said measuring equipment provides equipment for spectral spatial decomposition of a measuring beam after having passed through a foreign gas sample and a series of detectors, arranged side by side.

57. The apparatus of claim 55, wherein said measuring equipment provides a UV irradiator and equipment for detecting UV radiation in a range from 190 to 390 nm.

58. The apparatus of claim 55, wherein said equipment comprises spectroscopy devices having a measuring cell for conveying an extracted gas sample.

59. The apparatus of claim 58, wherein said measuring cell is substantially cylindrical and elongated.

60. The apparatus of claim 59, wherein UV light is irradiated into said measuring cell substantially in a longitudinal direction thereof.

61. The apparatus of claim 59, wherein said measuring cell comprises reflectors at both ends thereof for at least eightfold reflection of irradiated UV light.

62. The apparatus of claim 58, wherein said measuring cell has a rigid connection to at least one tube arranged in parallel to a direction of extension of said measuring cell.

63. The apparatus of claim 62, wherein said measuring cell has a rigid connection, on both sides, with at least one tube arranged in parallel to a direction of extension of said measuring cell.

64. The apparatus of claim 62, wherein said at least one tube is made of material having a smaller or a same thermal expansion coefficient as glass.

65. The apparatus of claim 64, wherein said at least one tube is made of a same material as said measuring cell.

66. The apparatus of claim 62, wherein at least one end-side connecting link of said measuring cell has at least one first parabolic reflector for feeding and adjusting a light beam from a light source into said measuring cell.

67. The apparatus of claim 66, wherein an end-side connecting link comprises a second parabolic reflector for uncoupling the light beam reflected at an other end-side link.

68. The apparatus of claim 66, wherein said light source is a light source radiating in an UV range, and further comprising a detector, a spectrometer, or a silicon array detector.

69. The apparatus of claim 62, wherein said measuring cell has a length between 50 and 150 cm or in a range of 100 cm.

70. The apparatus of claim 67, wherein the uncoupled light beam is detected via a lock-in amplifier.

71. The apparatus of claim 67, wherein the light beam is coupled into said measuring cell from an optical fiber and/or uncoupled from said measuring cell into an optical fiber.

72. The apparatus of claim 62, wherein said measuring cell is thermostatic.

73. The apparatus of claim 66, wherein said light source is formed by a laser, at least sections of said measuring cell forming a cavity of said laser.

74. The apparatus of claim 66, wherein said light source is a spontaneous emission source.

75. The apparatus of claim 55, further comprising means for injecting a neutral gas into the container and for extracting a foreign gas sample from the container.

76. The apparatus of claim 55, further comprising means for tightly placing a measuring head onto an opening of the container to be examined.

77. The apparatus of claim 76, wherein said placing means has a hydraulic or pneumatic cylinder for disposing said measuring head onto the opening of the container.

78. The apparatus of claim 76, further comprising a light barrier for activation of a placing process.

79. The apparatus of claim 55, further comprising means for continuous or discontinuous conveyance of the container.

80. The apparatus of claim 79, wherein said measuring head is carried along by a moved container.

81. The apparatus of claim 76, wherein said placing means lifts said measuring head off the container after sample extraction.

82. The apparatus of claim 76, further comprising a guide curve against which said measuring head is urged to return to a starting position thereof.
